(19) United States
(12) Patent Application Publication
(10) Pub. No.: US 2008/0093001 A1
(43) Pub. Date: Apr. 24, 2008

(54) Heavy duty tire

(75) Inventor: Toshiaki Ono, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd., Kobe-shi (JP)

(21) Appl. No.: 11/896,493

(22) Filed: Aug. 31, 2007

(30) Foreign Application Priority Data
Sep. 4, 2006 (JP) 2006-239261

(51) Int. Cl. B60C 5/14

(52) U.S. Cl. 152/510

(57) ABSTRACT

A heavy duty tire comprises: an inner liner of an air-impermeable rubber compound disposed inside a carcass and extending into each bead portion; and a chafer made of a hard rubber compound and comprising a base part, an axially inner part and an axially outer part extending along the bottom surface, an axially inner surface and an axially outer surface of the bead portion, respectively. The axially inner part of the chafer overlaps with the inner liner on the axially inside of the inner liner. Between the axially inner part and the inner liner, a first insulation layer made of a rubber compound superior in the tackiness is disposed.

### BACKGROUND OF THE INVENTION

The present invention relates to a pneumatic tire, more particularly to a bead structure suitable for heavy duty tires such as truck/bus tires.

In general, a pneumatic tire designed to be used without a tire tube is provided with an inner liner made of an air-impermeable rubber compound. The inner liner extends from the bead to bead so as to cover the inside of the tire. In the case of heavy duty tires, e.g. truck/bus tires and the like, in comparison with passenger car tires for example, their service conditions are very severe, and the heavy duty tires are often retreaded and reused. Further, tire rotations are often made. If mounting and demounting operations are thus repeated, the sealing effect of the inner liner is liable to deteriorate near the bead toe because such near-toe portion of the inner liner has many occasions to contact directly or indirectly with rim flanges and tire tools, and receive large forces and shear stress. Accordingly, there is a high possibility that the sealing is broken in the near-toe portion.

### SUMMARY OF THE INVENTION

It is therefore, an object of the present invention to provide a heavy duty tire having highly durable bead structures which can prevent the inner liner from being damaged and which can withstand a number of mounting and demounting operations.

According to the present invention, a heavy duty tire comprises:

an inner liner made of an air-impermeable rubber compound disposed inside a carcass and extending into each bead portion; and

a chafer made of a hard rubber compound and comprising a base part, an axially inner part and an axially outer part extending along the bottom surface, an axially inner surface and an axially outer surface of each bead portion, respectively;

the axially inner part of the chafer overlaps with the inner liner on the axially inside of the inner liner, and

between the axially inner part and the inner liner, a first insulation layer made of a rubber compound superior in tackiness is disposed.

Therefore, the radially inner edge portion of the inner liner is covered with the axially inner part of the chafer to prevent damage of the inner liner, and

the first insulation layer improves the bond between the axially inner part and the inner liner, and the deterioration of the sealing effect due to separation can be prevented.

### BRIEF DESCRIPTION OF THE DRAWINGS

FIG. 1 is a cross sectional view of a heavy duty tire according to the present invention.

FIG. 2 is an enlarged cross sectional view of the bead portion thereof.

### DESCRIPTION OF THE PREFERRED EMBODIMENT(S)

An embodiment of present invention will now be described in detail in conjunction with accompanying drawings.

In the drawings, heavy duty tire 1 according to the present invention has a tread portion 2; a pair of sidewall portions 3; and a pair of axially spaced bead portions 4 each with a bead core 5 therein, and provided with a carcass 6 extending between the bead portions 4 through the tread portion 2 and sidewall portion 3; and a belt 7 disposed radially outside the carcass 6 in the tread portion 2. The inner surface of the tire 1 is covered with an inner liner 10 made of an air-impermeable rubber compound.

In this application, unless otherwise noted, various dimensions and positions about the tire refer to those under such a condition that the tire not mounted on a wheel rim is held vertically by supporting the bead portions of which distance between the bead cores (from center to center) is adjusted to the same distance as that of the tire mounted on a standard wheel rim and inflated to a standard pressure but loaded with no tire load.

The standard wheel rim is a wheel rim officially approved for the tire by standard organization, i.e. JATMA (Japan and Asia), T&RA (North America), ETRTO (Europe), STRO (Scandinavia) and the like.

The standard pressure and the standard tire load are the maximum air pressure and the maximum tire load for the tire specified by the same organization in the Air-pressure/Maximum-load Table or similar list. For example, the standard wheel rim is the “standard rim” specified in JATMA, the “Measuring Rim” in ETRTO, the “Design Rim” in TRA or the like. The standard pressure is the “maximum air pressure” in JATMA, the “Inflation Pressure” in ETRTO, the maximum pressure given in the “Tire Load Limits at various Cold Inflation Pressures” table in TRA or the like. The standard load is the “maximum load capacity” in JATMA, the “Load Capacity” in ETRTO, the maximum value given in the above-mentioned table in TRA or the like.

The undermentioned bead base line BL is a straight line drawn parallel to the rotational axis of the tire at a radial position corresponding to the wheel rim diameter of the standard wheel rim.

The above-mentioned carcass 6 is composed of at least one ply 6A of cords arranged radially at an angle in a range of from 70 to 90 degrees with respect to the tire equator Co, extending between the bead portions 4 through the tread portion 2 and sidewall portions 3 and turned up around the bead core 5 in each bead portion 4 from the axially inside to the axially outside of the tire to form a pair of turnup portions 6b and a main portion 6a therebetween. For the carcass cords, organic fiber cords, e.g. polyester, nylon, rayon, aromatic polyamide and the like or metallic cords can be used. In this embodiment, the carcass 6 is composed of a single ply 6A of steel cords arranged radially at an angle of 90 degrees with respect to the tire equator Co.

The belt 7 is disposed on the crown portion of the carcass 6 and comprises at least three plies of parallel steel cords including two cross breaker plies 7A and 7B extending across the almost entire tread width. In this example, the belt 7 is composed of four plies of parallel steel cords: the radially innermost ply 7A of steel cords laid at an angel in a range of 50 to 70 degrees with respect to the tire equator CO, and second-fourth plies 7B, 7C and 7D of steel cords laid at angles of not more than 30 degrees with respect to the tire equator Co.

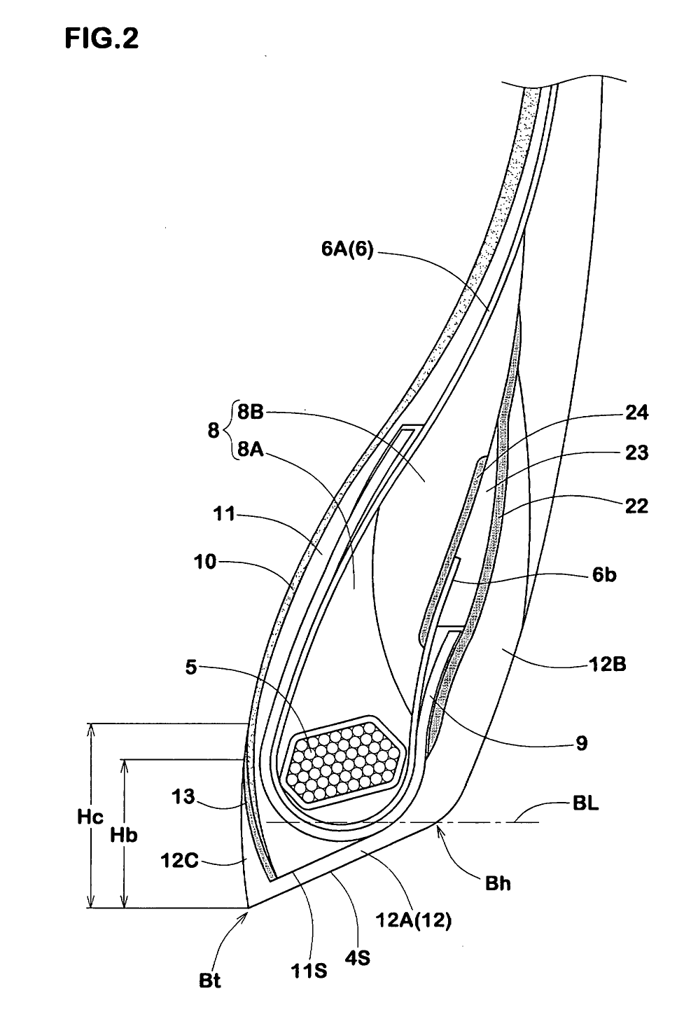

As shown in FIG. 2, each of the bead portions 4 is provided with the above-mentioned bead core 5, a bead apex 8, a bead reinforcing layer 9, a chafer 12, and a first insulation layer 13.

The bead core 5 is formed by winding a steel wire into a specific cross sectional shape in a predetermined order.

In this example, the cross sectional shape is a flattened hexagonal shape having a radially inner side which is longest and almost parallel with the bead bottom 4S.

The bead apex 8 is disposed between the turned up portion 6b and main portion 6a of the carcass 6. The bead apex 8 extends radially outwardly from the radially outside of the bead core 5, while tapering towards the radially outer end thereof. The bead apex 8 in this example is made up of a radially inner stiffener 8A on the bead core 5, and a radially outer buffer 8B spliced with the stiffener 8A. The buffer is softer than the stiffener, and for example, the JIS type-A durometer hardness of the stiffener is 75 to 90, and that of the buffer is 45 to 65.

The bead reinforcing layer 9 extends along the carcass 6 in a U-shaped cross sectional shape, passing between the bead bottom 4S and the radially inner end of the carcass 6, and as a result, the layer 9 has a base part beneath the bead core, an axially outer part extending radially outwardly along the turned up portion 6b, and an axially inner part extending radially outwardly along the main portion 6a. The bead reinforcing layer 9 is composed of one ply of steel cords arranged at an angle in a range of 15 to 60 degrees (under the bead core) with respect to the tire circumferential direction.

The above-mentioned inner liner 10 is made of an air-impermeable rubber compound such as butyl-based rubber compounds comprising at least 60 parts by mass, preferably at least 80 parts by mass, more preferably 100 parts by mass, of butyl rubber and/or its derivatives with respect to 100 parts by mass of rubber component. The butyl-based rubber may comprise one or more kinds of diene rubber such as natural rubber (NR), isoprene rubber (IR), butadiene rubber (BR) and styrene-butadiene rubber (SBR), as other parts of the rubber component than the butyl rubber (and derivatives). As to the derivatives of butyl rubber, halogenated butyl rubber such as chlorinated butyl rubber and a brominated butyl rubber can be used. Aside from the butyl rubber and its derivatives, a halogenated isobutylene-paramethylstyrene copolymer can be used instead.

The inner liner 10 extends continuously from the bead to bead, defining the inner surface of the tire, and as shown in FIG. 2, the radially inner end reaches to a position near the bead bottom 4S beyond the bead base line BL. Excepting the edges, the inner liner 10 has a thickness in a range of 1.0 to 2.0 mm. Therefore, moisture existing in the tire cavity can be prevented from penetrating into the bead portion 4 and the resultant deterioration can be avoided.

On the outside of the inner liner 10, a second insulation layer 11 is disposed so as to cover the inner liner 10 entirely. The function of the second insulation layer 11 is to prevent direct contacts of the inner liner 10 with the carcass cords due to rubber flow during tire vulcanization and to improve the bond between the inner liner 10 and the carcass 6. For that purpose, the second insulation layer 11 is made of natural-rubber based compound superior in the adhesiveness which comprises at least 60 parts by mass, preferably at least 80 parts by mass, more preferably 100 parts by mass, of natural rubber (NR), with respect to 100 parts by mass of rubber component. The natural-rubber based compound may comprise isoprene rubber (IR) and/or butadiene rubber (BR), as other parts of the rubber component than the natural rubber.

In this embodiment, since the bead reinforcing layers 9 are disposed, in a range between the radially outer ends of the axially inner parts of the bead reinforcing layers 9, the second insulation layer 11 abuts on the carcass 6. But, in a range radially inside the radially outer ends, the second insulation layer 11 abuts on the bead reinforcing layers 9 (if the layers 9 are not provided, abuts on the carcass 6).

The radially inner end portion of the second insulation layer 11 is gradually increased in the thickness towards its radially inner end 11S. The radially inner end 11S has a relatively wide surface parallel with the bead bottom face 4S.

The chafer 12 is made of a hard rubber compound and the JIS type-A durometer hardness thereof is from 70 to 85. In view of the wear resistance, impact resilience, aging resistance and the like, a rubber compound comprising 20 to 60 parts by mass of natural rubber (NR), and 80 to 40 parts by mass of butadiene rubber (BR), with respect to 100 parts by mass of rubber component can be suitably used to make the chafer 12. The chafer 12 comprises a base part 12A, an axially outer part 12B and an axially inner part 12C. The base part 12A extends from the bead toe Bt to the bead heel Bh, forming the bead bottom surface 4S. The axially outer part 12B extends radially outwardly from the bead heel Bh, forming the axially outer surface of the bead portion 4 which comes into contact with the rim flange, and the radially outer edge thereof is spliced with a sidewall rubber. The axially inner part 12C extends radially outwardly from the bead toe Bt, forming an axially inner surface of the bead portion 4. The axially inner part 12C is tapered from its radially inner end to radially outer end.

The axially inner part 12C of the chafer 12 extends on the axially inner side of the inner liner 10, and the above-mentioned first insulation layer 13 is disposed therebetween.

In order to prevent the inner liner 10 from being damaged by the rim flange and tire tools during tire mounting/demounting operations, the radial height Hb of the radially outer end of the axially inner part 12C from the bead toe Bt is more than 3.0 mm, and the radially outer end is positioned radially outside the bead base line BL. It is however, preferable that the height Hb is at most 35.0 mm in view of the molding efficiency.

The radially outer end (height HC) of the first insulation layer 13 is positioned radially outside the radially outer end (height Hb) of the inner part 12C (Hb<Hc), and the radial distance between these two ends (namely, height difference HC-Hb) is set in a range of 3 to 10 mm.

In the range where the axially inner part 12C overlaps with the inner liner 10, the first insulation layer 13 has a thickness in a range of not less than 0.5 mm, preferably not less than 0.7 mm, but not more than 3.0 mm, preferably not more than 1.5 mm.

The first insulation layer 13 is made of natural-rubber based compound comprising at least 60 parts by mass, preferably at least 80 parts by mass, of natural rubber (NR), with respect to 100 parts by mass of rubber component. This natural-rubber based compound may comprise isoprene rubber (IR) and/or butadiene rubber (BR), as other parts of the rubber component than the natural rubber. Therefore, in the unvulcanized states, the first insulation layer 13 is superior in tackiness to the chafer 12. Accordingly, when building a raw tire, the first insulation layer 13 can prevent the axially inner part 12C from coming unstuck from the inner liner 10. This can prevent a decrease (and undesirable variation) of the height Hb due to the unstuck. Further, even after the vulcanization, the first insulation layer 13 can provide good adhesivity to both of the axially inner part 12C and the inner liner 10.

Thus, separation failure between the axially inner part 12C and inner liner 10 can be effectively prevented.

If the above-mentioned thickness of the first insulation layer 13 is less than 0.5 mm, then a defect (such as a through hole) easily occurs in the calendar process for making the raw first insulation layer. If the thickness is more than 3.0 mm, then the heat generation in the calendar process increases, and the desirable tackiness is lost.

Further, in view of the adhesivity, it is preferable that the hardness of the vulcanized first insulation layer 13 is smaller than that of the vulcanized inner liner 10.

Incidentally, additives (reinforcing agent, vulcanizing agent, vulcanization accelerator and the like) can be added into the above-mentioned compounds for the inner liner 10, chafer 12, first insulation layer 13 and second insulation layer 11.

In order to enhance the tackiness, preferably 2.0 to 4.0 phr of a tackifier, e.g. coumarone resins, phenol resins, terpene resins, petroleum hydrocarbon resins, rosin derivatives and the like can be further added.

The first insulation layer 13 and the second insulation layer 11 can be made of the same compound. This is preferred in view of the production efficiency, cost and the like.

In this embodiment, the bead portion 4 is further provided with:

(1) an axially outer buffer layer 22 which is disposed between the axially outer part of the bead reinforcing layer 9 and the axially outer part 12B of the chafer 12, and extends radially outwardly beyond the radially outer ends of the bead reinforcing layer 9, carcass turned up portion 6b and axially outer part 12B;

(2) a middle buffer layer 23 which is disposed between the axially outer buffer layer 22 and the carcass turned up portion 6b, and extends radially outwardly from the radially outer end of the axially outer part of the bead reinforcing layer 9 beyond the radially outer end of the carcass turned up portion 6b; and

(3) an axially inner buffer layer 24 which is disposed between the buffer 8B and the carcass turned up portion 6b, and extends radially outwardly beyond the radially outer end of the carcass turned up portion 6b.

The buffer layers 22, 23 and 24 are each made of rubber compound softer than the chafer 12 and the buffer 8B. The hardness of the above-mentioned rubber layers are as follows: chafer 12>buffer layer 22>buffer layer 23>buffer layer 24>buffer 8B.

Thus, the ends of the bead reinforcing layer 9 and carcass turned up portion 6b are enwrapped in the buffer layers 22, 23 and 24, and ply edge separation failure, cord end loose and the like can be effectively prevented.

While description has been made of one particularly preferable embodiment of the present invention, the illustrated embodiment should not be construed as to limit the scope of the present invention; various modifications are possible without departing from the scope of the present invention.

Comparison Test

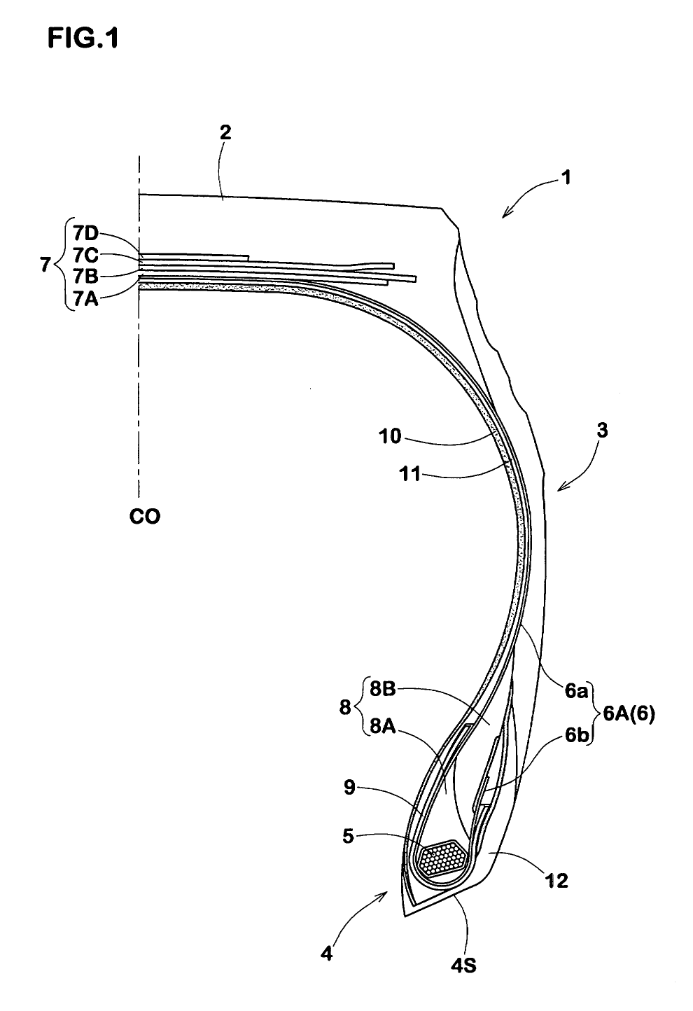

Based on the structure illustrated in FIG. 1 and FIG. 2, two types of heavy duty radial tires were prepared, wherein one was an exemplary tire according to the present invention, and the other was a comparative tire being same as the exemplary tire except that the first insulation layer was omitted.

When making the raw tires, in the case of the exemplary tire, the inner liner (namely, unvulcanized rubber sheet) including the first insulation layer (namely, unvulcanized narrow rubber strip) applied to each edge portion thereof in advance was used, whereas in the case of comparative tire, the inner liner only was used.

The rubber compounds of the first and second insulation layers, inner liner and chafer are shown in Table 1.

The design height Hb was 25 mm, and the width and thickness of the unvulcanized narrow rubber strip were 20 mm and 1 mm, respectively. The finished height Hb was measured at 100 circumferential points. Then, the average value of the 100 measurement values, the fluctuation range (difference between maximum and minimum) and the standard deviation were computed. As a result, the exemplary tire marked an average value of 25.8 mm, a fluctuation range R of 9 mm, and a standard deviation of 1.97, whereas the comparative tire marked an average value of 17.9 mm, a fluctuation range of 30 mm, and a standard deviation of 6.42.

That is, in the exemplary tire, the height Hb was stable, and accordingly, it is possible protect the inner liner 10 effectively.

TABLE 1

| Rubber compound | 1st and 2nd insulation | Inner liner | Chafer |
|---|---|---|---|
| Natural rubber | 100 | — | 40 |
| Butadiene rubber | — | — | 60 |
| Butyl rubber | — | 100 | — |
| Carbon | | | |
| GPF | — | 65 | — |
| HAF | — | — | 65 |
| ISAF | 45 | — | — |
| Oil | 6 | 13 | — |
| Tackifier | 3 | 4 | — |
| Age resistor | 1.5 | — | 4 |
| Stearic acid | 2 | 1.2 | 2 |
| Hydrozincite | 6 | 3 | 3 |
| Vulcanizing agent (sulfur) | 2.5 | 0.5 | 1 |
| Vulcanization accelerator | 0.7 | 1.5 | 3 |

1. A heavy duty tire comprising
a tread portion,
a pair of sidewall portions,
a pair of axially spaced bead portions each with a bead core therein,
a carcass extending between the bead portions,
an inner liner made of an air-impermeable rubber compound disposed inside the carcass, the inner liner extending into each said bead portion,
a chafer made of a hard rubber compound and comprising a base part, an axially inner part and an axially outer part extending along the bottom surface, an axially inner surface and an axially outer surface of each said bead portion, respectively, wherein
the axially inner part of the chafer overlaps with the inner liner on the axially inside of the inner liner, and
between the axially inner part and the inner liner, a first insulation layer made of a rubber compound superior in tackiness is disposed.

2. The heavy duty tire according to claim 1, wherein
the air-impermeable rubber compound of the inner liner comprises at least 60 parts by mass of butyl rubber and/or its derivative with respect to 100 parts by mass of rubber component,
the hard rubber compound of the chafer comprises 20 to 60 parts by mass of natural rubber with respect to 100 parts by mass of rubber component, and
the rubber compound of the first insulation layer comprises at least 60 parts by mass of natural rubber, with respect to 100 parts by mass of rubber component.

3. The heavy duty tire according to claim 1, wherein
the axially inner part of the chafer extends radially outwardly beyond a bead base line, and
the inner liner extends radially inwardly beyond the bead base line.

4. The heavy duty tire according to claim 1, wherein
the radially outer end of the first insulation layer is positioned radially outside the radially outer end of the axially inner part of the chafer.

5. The heavy duty tire according to claim 1, wherein
in the range where the axially inner part of the chafer overlaps with the inner liner, the first insulation layer has a thickness in a range of from 0.5 to 3.0 mm.

6. The heavy duty tire according to claim 1, wherein
between the inner liner and the carcass, a second insulation layer made of the same rubber compound as the first insulation layer is disposed.
